(19) United States
(12) Patent Application Publication
(10) Pub. No.: US 2026/0270291 A1
(43) Pub. Date: Sep. 10, 2026

(54) CENTRALIZED MULTI-APPLICATION PREFILL RESTRICTION FRAMEWORK

(71) Applicant: HARTFORD FIRE INSURANCE COMPANY, Hardford, CT (US)

(72) Inventors: Edward Scott Gaidos, Ellington, CT (US); Raja Vignesh Vaithiyalingam, South Windsor, CT (US); Pranjal Sharma, Huntersville, NC (US); Sarah L Rivord, Novi, MI (US); Jessica Taggett, Watertown, CT (US); Chandra Bhat, Rocky Hill, CT (US)

(21) Appl. No.: 19/073,432

(22) Filed: Mar. 7, 2025

(51) Int. Cl. H04L 9/40; G06F 9/54

(52) U.S. Cl. CPC H04L 63/1441; G06F 9/547; H04L 63/1416

(57) ABSTRACT

A prefill restriction framework for an enterprise may include a configuration data store with electronic records associated with enterprise applications including, for each application, at least one application identifier and associated prefill restriction. A prefill restriction tool, coupled to the configuration data store, may receive a prefill check request, including an application identifier and a transaction identifier, from a consuming application via API. The prefill restriction tool can then access the configuration data store to determine a prefill restriction associated with the consuming application. A prefill check can then be automatically performed based on the prefill restriction and transaction identifier, and the prefill restriction tool may transmit a response to the consuming application indicating a result of the prefill check.

### TECHNICAL FIELD

The present application generally relates to computer systems and more particularly to computer systems that are adapted to accurately, securely, and/or automatically support a prefill restriction framework (e.g., in connection with a user interface) for an enterprise.

### BACKGROUND

An enterprise may interact with clients (e.g., potential customers) through various applications and a User Interface (“UI”). For example, an application might request information from a user and calculate a customized price quote for goods or services. To improve the user experience, an enterprise may “prefill” UI elements to streamline user input by automatically filling in fields with relevant data (reducing the need for users to manually enter information). For example, the enterprise server may prefill web browser form fields with a user's contact details and other information based on their account information.

FIGS. 1A through 1C illustrate a prefill example. In particular, an enterprise UI display 101 may include a user information data entry portion 111 and a vehicle information data entry portion 121. FIG. 1B shows a UI display 102 after the user completes a user information data entry portion 112 (e.g., with a name and driver license number) without completing a vehicle information data entry portion 122. When the user selects a “Submit” icon 132 (e.g., via a touchscreen or computer mouse pointer 192), the user information is submitted to the enterprise server. In response, the server may automatically determine vehicle information that is potentially associated with the user (e.g., based on department of motor vehicle records) and prefill that information in a vehicle information data entry portion 123 as shown by the UI display 103 of FIG. 1C. The user can correct the prefill information (if necessary) and proceed with the interaction.

Other prefill situations might involve a search bar (suggesting previous search terms or commonly used searched items), checkbox, or a dropdown menu (automatically selecting an option based on a user's location or preferences). Prefill benefits may include an improved user experience (by saving the user time and effort, making interactions smoother and more efficient), reduced errors (minimizing the risk of typos and data entry mistakes, and tailoring of the UI to an individual user's needs and preferences. Prefill information sources may include data stored in databases, user profiles, or previous interactions. Prefill operations may be performed in connection with web forms, mobile applications, etc.

In some cases, however, a malicious actor may inappropriately interact with an enterprise application and abuse the prefill feature. For example, they might flood the application with requests looking to determine which vehicles are owned by various people. To prevent such misuse, application developers may implement mechanisms to detect and prevent repeated requests from bad actors. Typically, application developers write this logic for each application where they need to implement restrictions (e.g., to temporarily block prefills when suspicious activity is noticed). It can be very difficult, however, to meet these objectives when creating an enterprise application. For example, it might be especially time-consuming and costly when there are a substantial number of applications, many different types of prefill restrictions, etc. that need to be supported. It would be desirable to provide improved systems and methods to accurately and/or automatically support a prefill restriction framework for an enterprise. Moreover, the results should be easy to access, understand, interpret, update, etc.

### SUMMARY OF THE INVENTION

According to some embodiments, systems, methods, apparatus, computer program code and means are provided to accurately and/or automatically support a prefill restriction framework for an enterprise in a way that provides fast, secure, and useful results and that allows for flexibility and effectiveness when responding to those results.

Some embodiments are directed to a prefill restriction framework for an enterprise with a configuration data store that contains electronic records associated with enterprise applications including, for each application, at least one application identifier and associated prefill restriction. A prefill restriction tool, coupled to the configuration data store, may receive a prefill check request, including an application identifier and a transaction identifier, from a consuming application via API. The prefill restriction tool can then access the configuration data store to determine a prefill restriction associated with the consuming application. A prefill check can be automatically performed based on the prefill restriction and transaction identifier, and the prefill restriction tool may transmit a response to the consuming application indicating a result of the prefill check.

Some embodiments comprise: means for receiving, by a back-end application computer server associated with a prefill restriction tool, a prefill check request, including an application identifier and a transaction identifier, from a consuming application of the enterprise via an API; means for accessing a configuration data store to determine a prefill restriction associated with the consuming application, wherein the configuration data store contains electronic records associated with enterprise applications including, for each application, at least one application identifier and associated prefill restriction; means for automatically performing a prefill check based on the prefill restriction and transaction identifier; and means for transmitting a response to the consuming application indicating a result of the prefill check.

In some embodiments, a communication device associated with a back-end application computer server exchanges information with remote devices in connection with interactive graphical user interfaces. The information may be exchanged, for example, via public and/or proprietary communication networks.

A technical effect of some embodiments of the invention is improved and computerized support of prefill restrictions that provide fast, secure, and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIGS. 1A through 1C illustrate a prefill example.

FIG. 2A is a high-level block diagram of an enterprise system in accordance with some embodiments.

FIG. 2B is a prefill restriction method according to some embodiments.

FIG. 3 is a prefill restriction API architecture in accordance with some embodiments.

FIG. 4 is a configuration flow architecture according to some embodiments.

FIG. 5 is a configuration table according to some embodiments.

FIG. 6 is a prefill check flow architecture in accordance with some embodiments.

FIG. 7 is a prefill check table in accordance with some embodiments.

FIG. 8A are some prefill cyber event examples according to some embodiments.

FIG. 8B is a prefill cyber event restriction method in accordance with

FIG. 9 illustrates relationships between tables according to some embodiments.

FIG. 10 is a prefill restriction cloud architecture according to some embodiments.

FIG. 11 is a prefill restriction operator or administrator display in accordance with some embodiments.

FIG. 12 is a block diagram of an apparatus according to some embodiments.

FIG. 13 is a tablet computer in accordance with some embodiments.

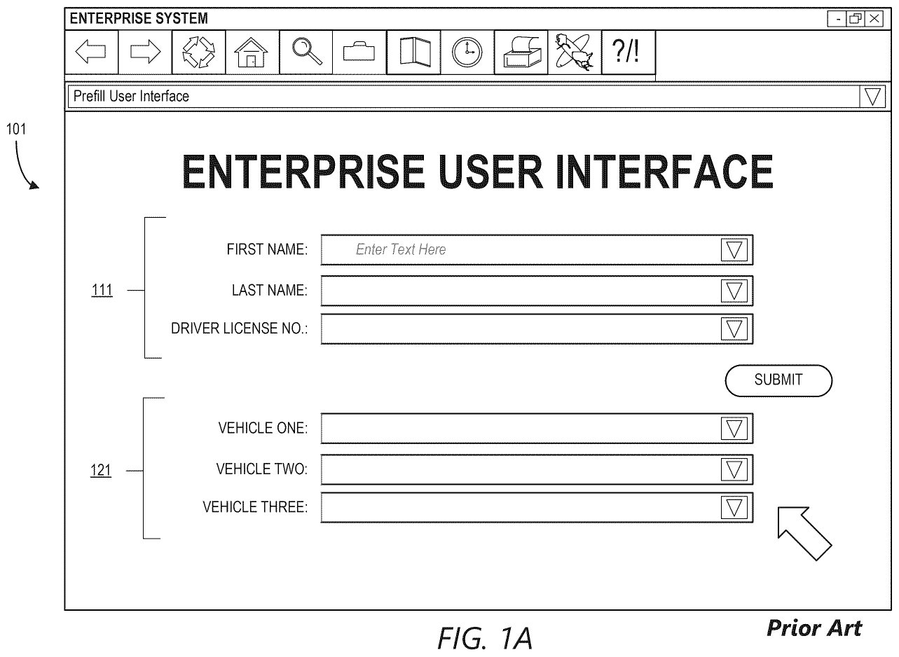

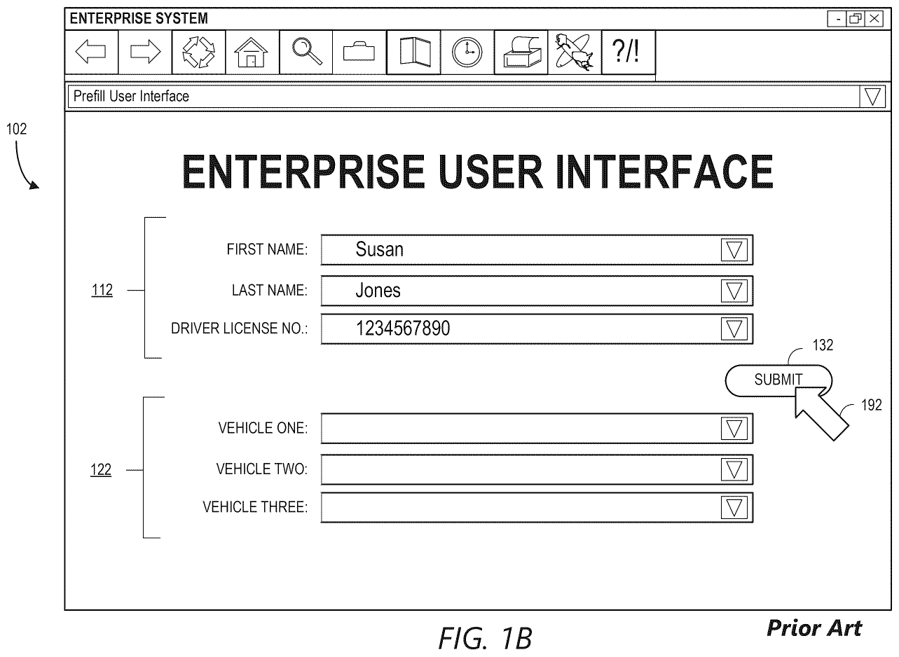

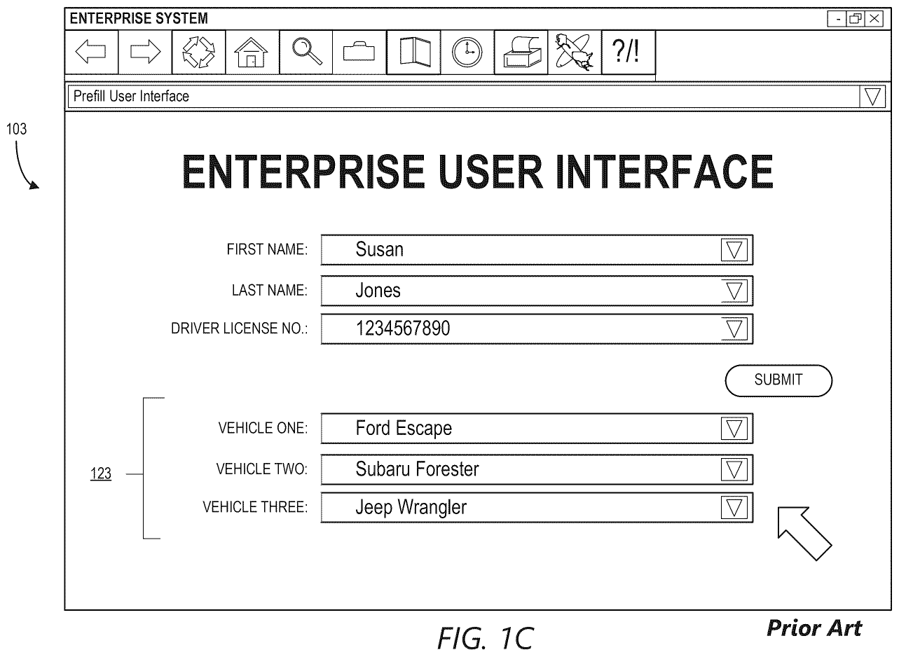

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data processing associated with a prefill restriction framework. The present invention is directed to more than merely a computer implementation of a routine or conventional activity previously known in the industry as it provides a specific advancement in the area of prefill restrictions by providing improvements in the operation of a computer system that automatically implements appropriate prefill restriction configurations for applications. The present invention provides improvement beyond a mere generic computer implementation as it involves the novel ordered combination of system elements and processes to provide improvements in the speed, security, and accuracy of such a prefill restriction tool for an enterprise. Some embodiments of the present invention are directed to a system adapted to automatically handle third-party data, aggregate information from multiple data sources, automatically respond to API requests in a way that reduces unnecessary messages or communications, etc. (e.g., to consolidate communications between parties within an enterprise). Moreover, communication links and messages may be automatically established, aggregated, formatted, modified, removed, exchanged, etc. to improve network performance (e.g., by reducing an amount of network messaging bandwidth and/or storage required to create allocation workflows or alerts, improve security, reduce the size of data stores, more efficiently collect, present, and utilize prefill restriction information and results, etc.).

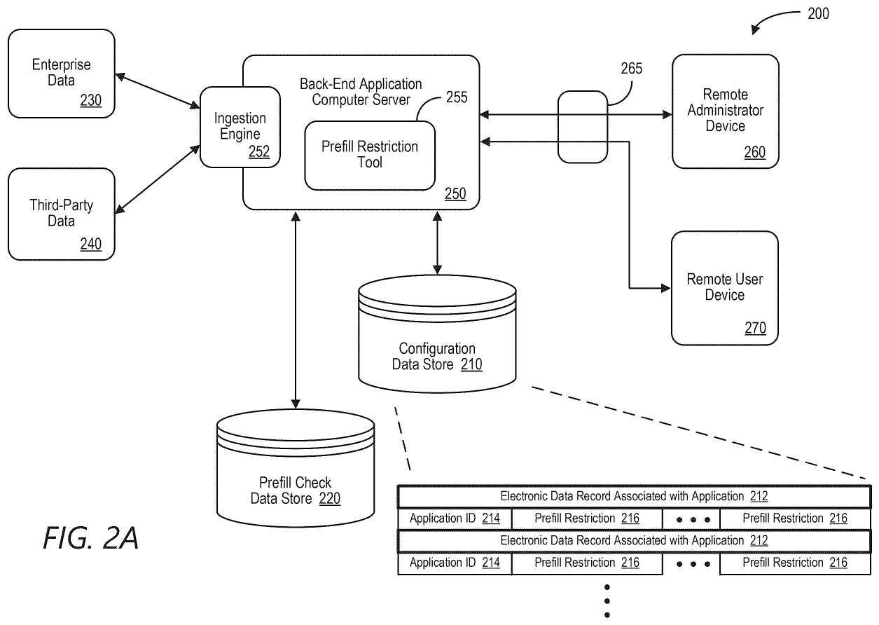

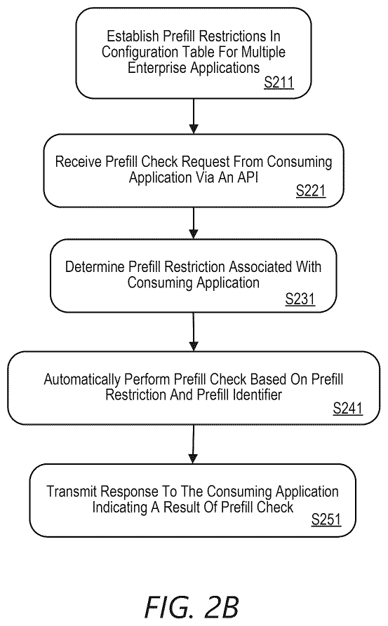

FIG. 2A is a high-level block diagram of an enterprise system 200 that may be provided according to some embodiments of the present invention. In particular, the system 200 includes a back-end application computer server 250 that may access information in a configuration data store 210 (e.g., storing a set of electronic records associated with applications 212, each record including, for example, an application identifier 214 and one or more prefill restrictions 216, etc.). The back-end application computer server 250 may also store information into other data stores, such as a prefill check data store 220, and utilize an ingestion engine 252 and a prefill restriction tool 255 to exchange and process messages and view, analyze, and/or update electronic records. As used herein, the term “prefill” may refer to the practice of automatically populating UI elements (e.g., form fields), which might be based on user information or previous interactions, to save time and improve the user experience.

The back-end application computer server 250 may also exchange information with a remote administrator device 260 and a remote user device 270 (e.g., via a firewall 265). According to some embodiments, an interactive graphical user interface platform of the back-end application computer server 250 may facilitate the creation and review of prefill restriction information, recommendations, alerts, and/or the display of results via one or more remote administrator computers (e.g., to summarize system 200 performance) and/or the remote user device 270. For example, the remote administrator device 260 may transmit annotated and/or updated information to the back-end application computer server 250. Based on the updated information, the back-end application computer server 250 may adjust data in the configuration data store 210 and the changes may (or may not) be used in connection with the remote user device 270.

Note that the back-end application computer server 250 and/or any of the other devices and methods described herein might be associated with a third party, such as a vendor that performs a service for an enterprise. The back-end application computer server 250 and/or the other elements of the system 200 might be, for example, associated with a Personal Computer (“PC”), laptop computer, smartphone, an enterprise server, a server farm, and/or a database or similar storage devices. According to some embodiments, an “automated” back-end application computer server 250 (and/or other elements of the system 200) may facilitate the automated access and/or update of electronic records in the data stores 210, 220 and/or the automated management of prefill restrictions. As used herein, the term “automated” may refer to, for example, actions that can be performed with little (or no) intervention by a human.

Devices, including those associated with the back-end application computer server 250 and any other apparatus described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 250 may store information into and/or retrieve information from the configuration data store 210, the prefill check data store 220, enterprise data 230, third-party data 240, etc. The data stores 210, 220 may be locally stored or reside remote from the back-end application computer server 250. As will be described further below, the configuration data store 210 may be used by the back-end application computer server 250 in connection with an interactive user interface to facilitate prefill restrictions for an enterprise. Although a single back-end application computer server 250 is shown in FIG. 2A, any number of such devices may be included. Moreover, various devices described herein might be combined according to embodiments of the present invention. For example, in some embodiments, the back-end application computer server 250 and configuration data store 210 might be co-located and/or may comprise a single apparatus.

The elements of the system 200 may work together to perform the various embodiments of the present invention. Note that the system 200 of FIG. 2A is provided only as an example, and embodiments may be associated with additional elements or components. According to some embodiments, the elements of the system 200 automatically transmit information associated with an interactive user interface display over a distributed communication network.

FIG. 2B is a prefill restriction method that might be performed by some or all of the elements of the system 200 described with respect to FIG. 2A, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S211, prefill restrictions are established in a configuration table for multiple enterprise applications. For example, a configuration request received from an administrator might include an application identifier, a transaction type, a transaction identifier type, a time duration type, a time duration, a threshold, a “disable” flag, a “requested by” identifier, an action, etc. Moreover, a response to the configuration request may include an “success” status, an “error” status, and a message explaining the status. In some embodiments, the prefill restriction tool is able to configure a time duration in accordance with minutes, hours, calendar days, business days, etc.

At S221, a back-end application computer server associated with a prefill restriction tool receives a prefill check request, including an application identifier and a transaction identifier (e.g., a communication address, an IP address, a user identifier, a state, a session identifier, etc.), from a consuming application of the enterprise via an API. According to some embodiments, the prefill check request further includes a transaction type and/or a transaction identifier type.

At S231, the prefill restriction tool may access the configuration data store to determine a prefill restriction associated with the consuming application. The prefill restriction might, for example, prevent more than a threshold number of transactions from a communication address, prevent more than a threshold number of transactions from a communication address within a predetermined period of time, prevent more than a threshold number of transactions from a communication address from a particular user, etc.

At S241, a prefill check is automatically performed based on the prefill restriction and transaction identifier. At S251, the prefill restriction tool may transmit a response to the consuming application indicating a result of the prefill check. The result of the prefill check might, for example, indicate that prefill is “enabled” when a number of transactions is within a threshold limit in a given time duration. As another example, the result of the prefill check might indicate that prefill is “disabled” when a number of transactions exceeds a threshold limit. According to some embodiments, the prefill check is performed in accordance with detection of a cyber event beginning and/or detection of a cyber event ending. Moreover, such detections may be based on artificial intelligence, such as a machine learning algorithm result.

In some embodiments, the prefill restriction tool is able to enable or disable prefill checks for specific configurations. Moreover, the prefill restriction tool may be able to whitelist transactions (e.g., to test the tool) and/or capture an incoming request from the consuming application in one place and perform the prefill check in another place or do both at same time.

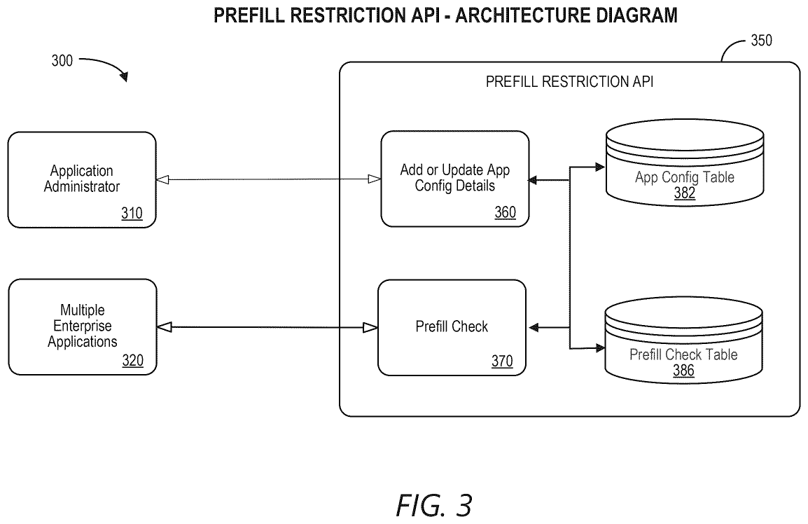

FIG. 3 is a prefill restriction API architecture 300 in accordance with some embodiments. An application administrator 310 or operator may exchange information with a prefill restriction API 350 to add or update configuration details 360 in an application configuration table 382. The prefill restriction API 350 may comprise a Representational State Transfer (“REST”) API that can be consumed by any application within an enterprise. The API 350 has a separate configuration table 382 where application specific thresholds can be configured and modified based on need. A REST end point may be exposed to consumer application teams to add or modify configuration details.

Multiple enterprise applications 320 exchange information with the prefill restriction API 350 to perform a prefill check 370 to be recorded in a prefill check table 386. That is, the API 350 may have a separate prefill check table 386 to store the incoming request received from a consumer application and uses the same to make the decision. A new REST end point may be exposed to consumer application teams to get the decision. In some embodiments, the entire prefill check 370 is performed within the enterprise. In other embodiments, some or all of this functionality may be performed by a third-party. For example, a vendor may analyze network volume metrics and indicate whether or not suspicious activity is likely (e.g., if a bot might be farming information). This information can then be used by the enterprise (either alone or in combination with other rules and parameters) to make a prefill decision.

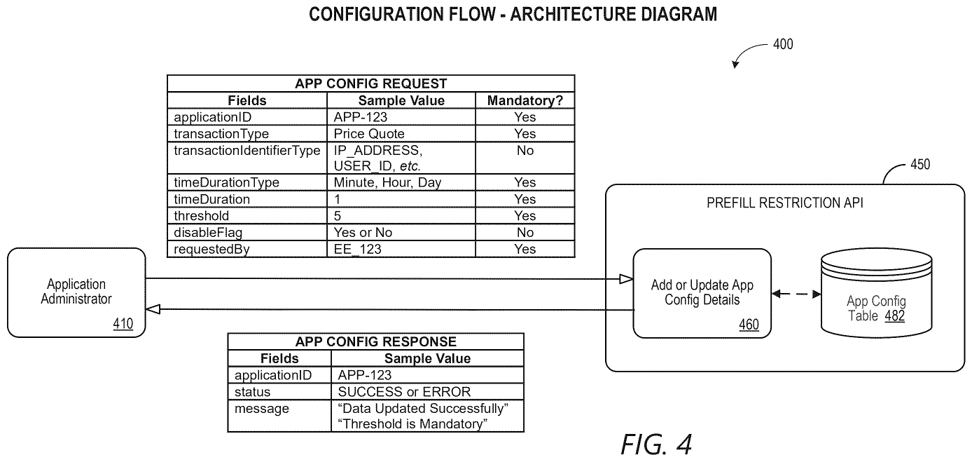

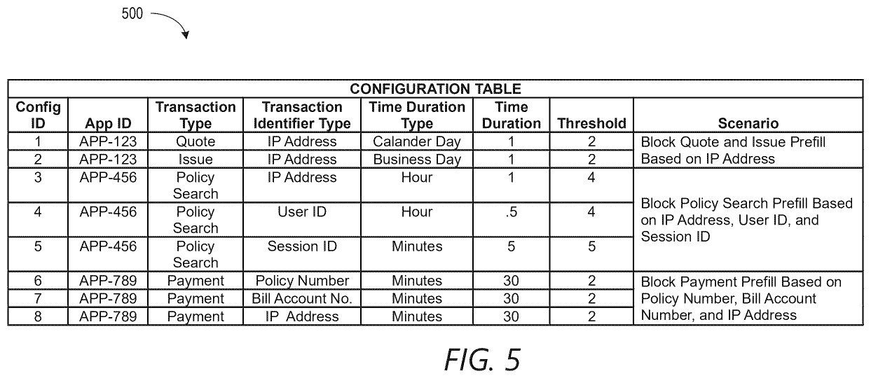

FIG. 4 is a configuration flow architecture 400 according to some embodiments. An application administrator 410 or operator may transmit an application configuration request to a prefill restriction API 450 to add or update configuration details 460 in an application configuration table 482. The application configuration request might specify an application identifier, a transaction type, a transaction identifier type, a time duration type, a time duration, a threshold, and a “disable” flag. The Prefill restriction API 450 responds with an application configuration that includes a status (that the update was a “success” or “error”) and a message providing a reason for that status. FIG. 5 is a configuration table 500 according to some embodiments. The configuration table 500 defines prefill restrictions for multiple enterprise applications.

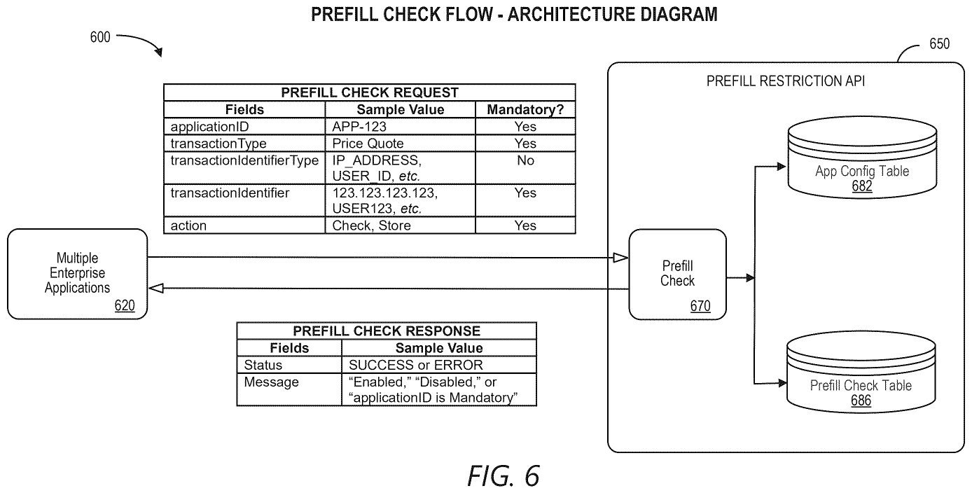

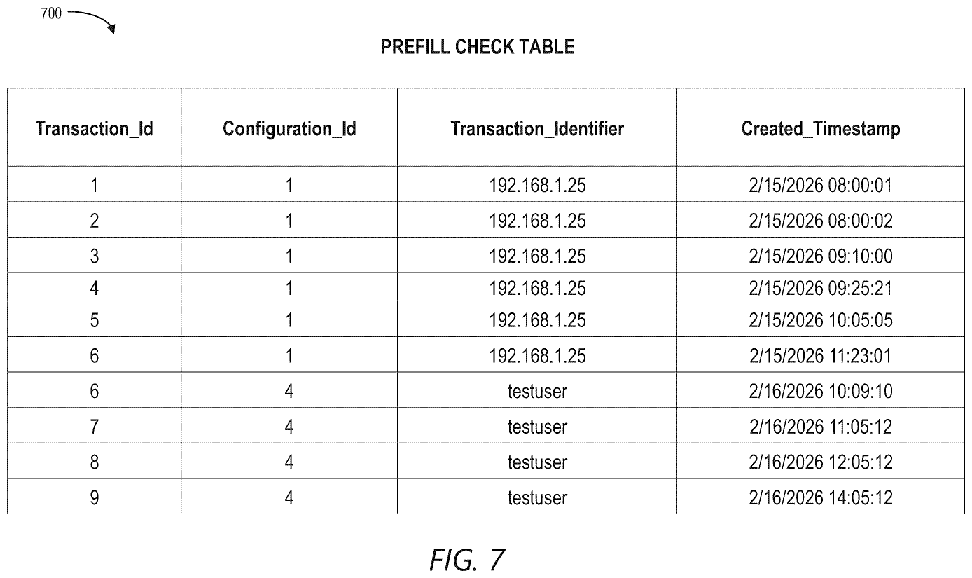

FIG. 6 is a prefill check flow architecture 600 in accordance with some embodiments. Multiple enterprise applications 620 exchange information with the prefill restriction API 650 to perform a prefill check 670 to be recorded in a prefill check table 686 based on information in an application configuration table 682. The API 650 has a separate prefill check table 686 to store the incoming request received from a consumer application. FIG. 7 is a sample prefill check table 700 in accordance with some embodiments.

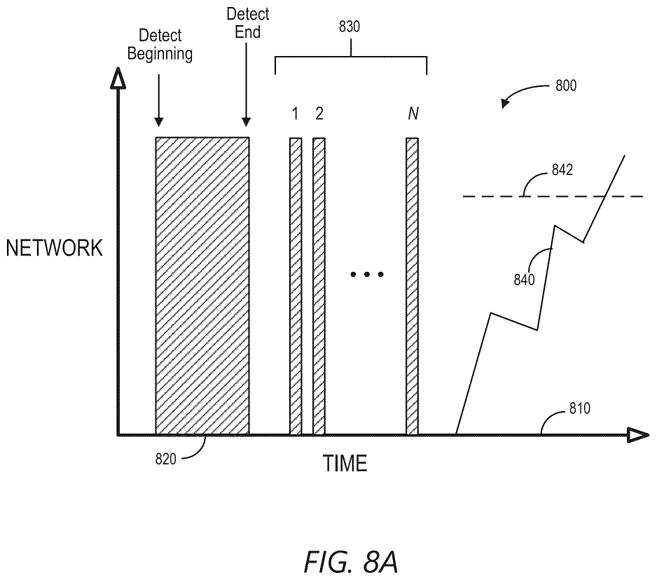

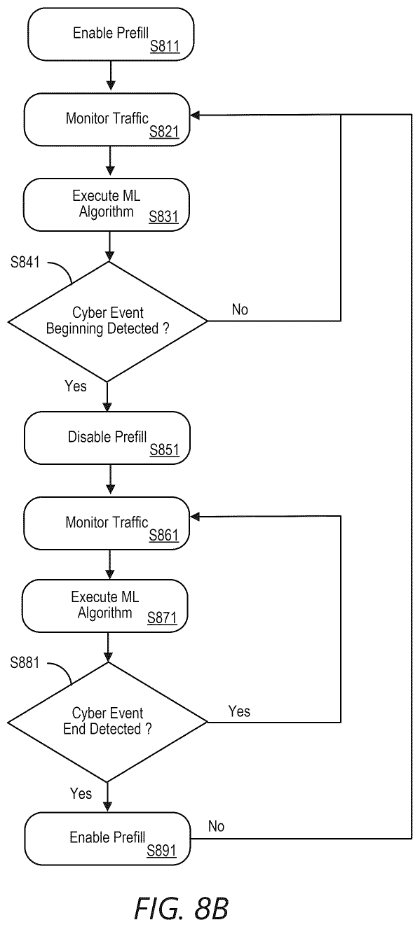

According to some embodiments, a prefill restriction is associated with a cyber event. FIG. 8A are some prefill cyber event examples 800 according to some embodiments. In particular, graph 810 shows network activity over a period of time. In some cases, a machine learning algorithm may be trained to detect a cyber event 820 beginning or a cyber event 820 end (and “turn off” prefill during the event 820). As another example, a series of events or detection 830 may trigger a prefill restriction. As still another example, a network parameter 840 could be monitored and a prefill action taken when a threshold 842 is exceeded.

FIG. 8B is a prefill cyber event restriction method in accordance with some embodiments. At S811, a UI prefill function may be enabled. At S821, network traffic is monitored and a machine learning algorithm is executed at S831. If no cyber event beginning (e.g., suspicious activity) is detected by the machine learning algorithm at S841, the process continues monitoring network traffic at S821. If a cyber event beginning is detected by the machine learning algorithm at S841, prefill is disabled at S851.

At S861, the system continues monitoring network traffic and a machine learning algorithm is executed at S871. If no cyber event end is detected by the machine learning algorithm at S881, prefill remains disabled and the process continues monitoring network traffic at S861. If a cyber event end is detected by the machine learning algorithm at S881, prefill is re-enabled at S891 and the process continues monitoring network traffic at S821.

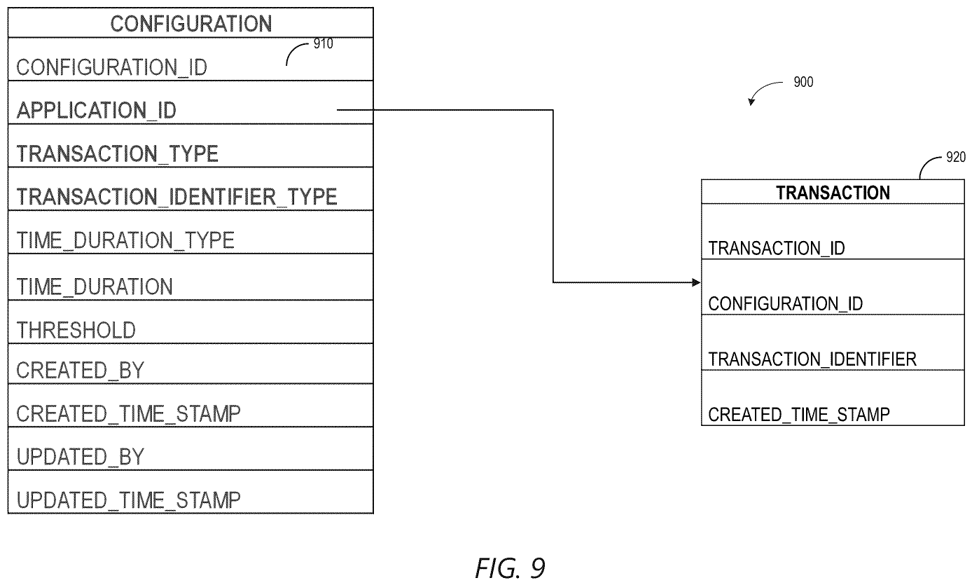

FIG. 9 illustrates relationships 900 between tables according to some embodiments. A configuration identifier in a configuration table 910 acts as a Primary Key (“PK”) that maps it to a Foreign Key (“FK”) in a prefill check or transaction table 920.

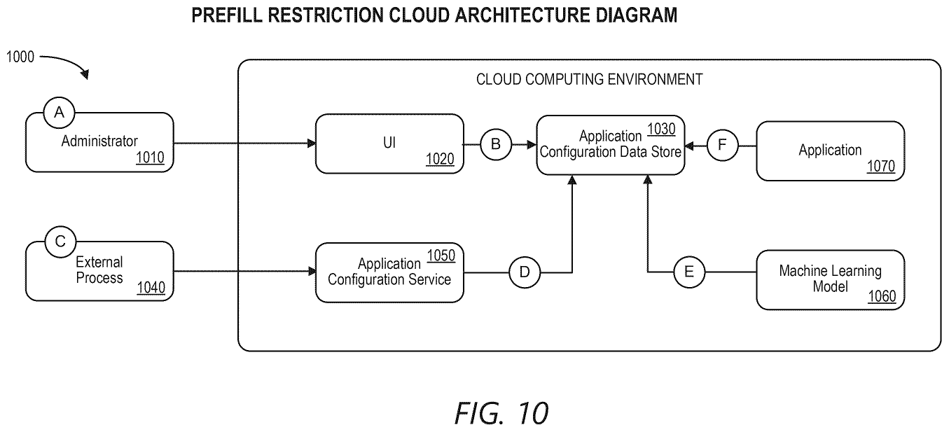

FIG. 10 is a prefill restriction cloud architecture 1000 according to some embodiments. At (A), an administrator 1010 uses a UI 1020 to enable or disable a data prefill (e.g., a third-party data prefill) configuration setting. At (B), the UI 1020 saves the data prefill enable or disable configuration setting to an application configuration data store 1030. At (C), an external process 1040 calls an application configuration service 1050 with enable or disable configuration setting. At (D), the application configuration service 1050 saves the data prefill enable or disable setting to the application configuration data store 1030. At (E), a machine learning model 1060 identifies a cyber event beginning or ending and saves enable or disable configuration setting to the application configuration data store 1030. As used herein, the phrase “machine learning” might refer to, for example, any artificial intelligence technique such as those associated with supervised learning, clustering, dimensionality reduction, structured predictions, anomaly detection, artificial neural networks, reinforcement learning, a Large Language Model (“LLM”), etc. At (F), an application 1070 reads the prefill enable or disable setting from the application configuration data store 1030 and then turns prefill “on” or “off” for the UI 1020 in substantially real time.

In this way, embodiments may implement a prefill restriction API to provide a modularized solution letting applications limit, control, and block any exploitation of prefill services by malicious actors. The applications can prevent a sudden surge of misuse by defining threshold limits for various services. Moreover, embodiments may provide functionalities that allow or deny a specific user or whole groups of users (e.g., all users in a certain country) from accessing an application or enable or disable a prefill function for a specific amount of time when a cyber event is detected. The consuming application calls the prefill restriction API to perform the necessary checks and get a decision to enable or disable prefill as response. The API can make decisions based on unique identifiers (e.g., application identifier, transaction type, and transaction identifier) with the capability to validate and respond with different responses to the consuming application based on the configured threshold, time duration, etc.

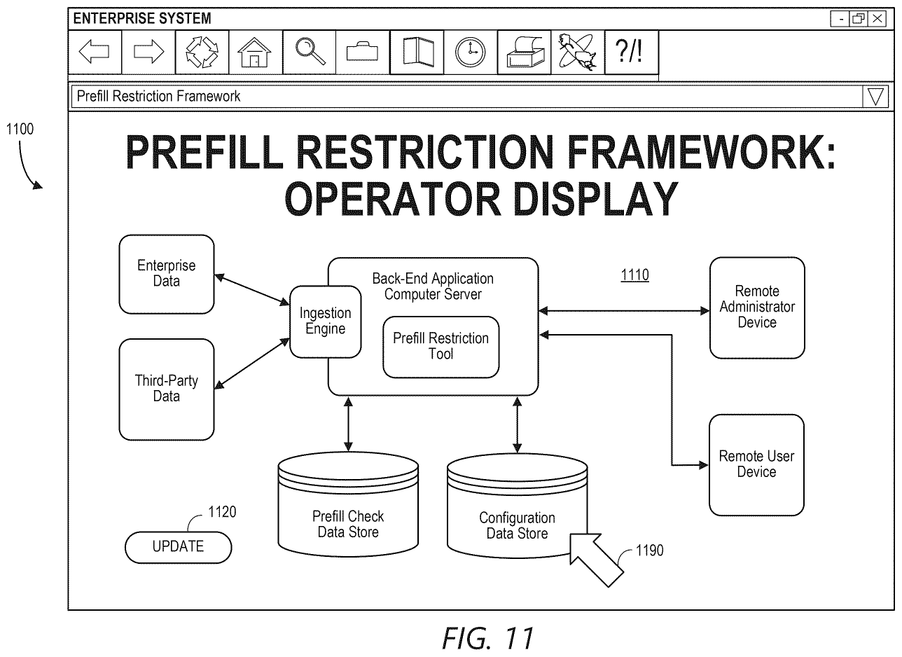

The operation of an enterprise prefill restriction framework may be controlled via a Graphical User Interface (“GUI”). For example, FIG. 11 is an enterprise prefill restriction framework operator or administrator display 1100 including graphical representations of elements of such a tool 1110 according to some embodiments. Selection of a portion or element of the display 1100 via a touchscreen or pointer 1190 might result in the presentation of additional information about that portion or element (e.g., a popup window presenting data mappings, prefill requirements and configurations, etc.) or let an operator or administrator enter or annotate additional information about prefill restrictions (e.g., based on changes to application configurations, prior prefill restriction results, etc.). An “Update” icon 1120 might let the administrator save updates and changes to the tool 1110.

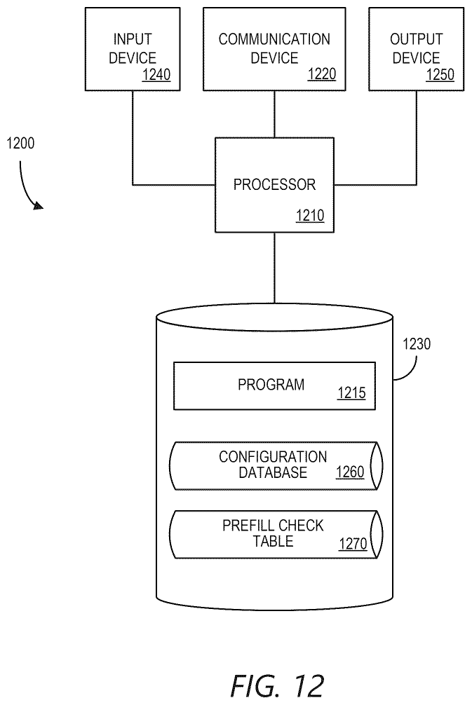

The embodiments described herein may be implemented using any number of different hardware configurations. For example, FIG. 12 illustrates an apparatus 1200 that may be, for example, associated with the enterprise prefill restriction system 200 described with respect to FIG. 2A (or any other system described herein). The apparatus 1200 comprises a processor 1210, such as one or more commercially available Central Processing Units (“CPUs”) in the form of one-chip microprocessors, coupled to a communication device 1220 configured to communicate via a communication network (not shown in FIG. 12). The communication device 1220 may be used to communicate, for example, with one or more remote cloud or on-premises systems, administrators, application developers, enterprise customers or clients, and/or other communication devices (e.g., PCs and smartphones). Note that communications exchanged via the communication device 1220 may utilize security features, such as those between a public internet user and an internal network of an insurance company and/or an enterprise. The security features might be associated with, for example, web servers, firewalls, and/or PCI infrastructure. The apparatus 1200 further includes an input device 1240 (e.g., a mouse and/or keyboard to enter information about prefill restrictions, application configurations, etc.) and an output device 1250 (e.g., to output reports regarding prefill restrictions, recommendations, alerts, etc.).

The processor 1210 also communicates with a storage device 1230. The storage device 1230 may comprise any appropriate information storage device, including combinations of magnetic storage devices (e.g., a hard disk drive), optical storage devices, mobile telephones, and/or semiconductor memory devices. The storage device 1230 stores a program 1215 and/or a prefill restriction tool or application for controlling the processor 1210. The processor 1210 performs instructions of the program 1215 and thereby operates in accordance with any of the embodiments described herein. For example, the processor 1210 may receive a prefill check request, including an application identifier and a transaction identifier, from a consuming application via API. The processor 1210 can then access the configuration data store to determine a prefill restriction associated with the consuming application. A prefill check can then be automatically performed by the processor 1210 based on the prefill restriction and transaction identifier, and a response to the consuming application indicating a result of the prefill check may be transmitted.

The program 1215 may be stored in a compressed, uncompiled and/or encrypted format. The program 1215 may furthermore include other program elements, such as an operating system, a database management system, and/or device drivers used by the processor 1210 to interface with peripheral devices.

As used herein, information may be “received” by or “transmitted” to, for example: (i) the apparatus 1200 from another device; or (ii) a software application or module within the apparatus 1200 from another software application, module, or any other source.

In some embodiments (such as shown in FIG. 12), the storage device 1230 further includes a configuration database 1260 and a prefill check table 1270. Note that the databases described herein are only examples, and additional and/or different information may be stored therein. Moreover, various databases might be split or combined in accordance with any of the embodiments described herein. For example, the configuration database and prefill check table might be combined and/or linked to each other within the program 1215.

Thus, embodiments may ensure application security by blocking requests from malicious actors. Embodiments may save application development team efforts to write application specific logic to make such decisions. Instead, they can just configure and call the API and get an appropriate decision. Embodiments may save infrastructure cost by maintaining all applications transaction details in one database. Such a centralized solution to take prefill restriction actions may be used across all of the applications within an enterprise because the approach can be platform and technology independent.

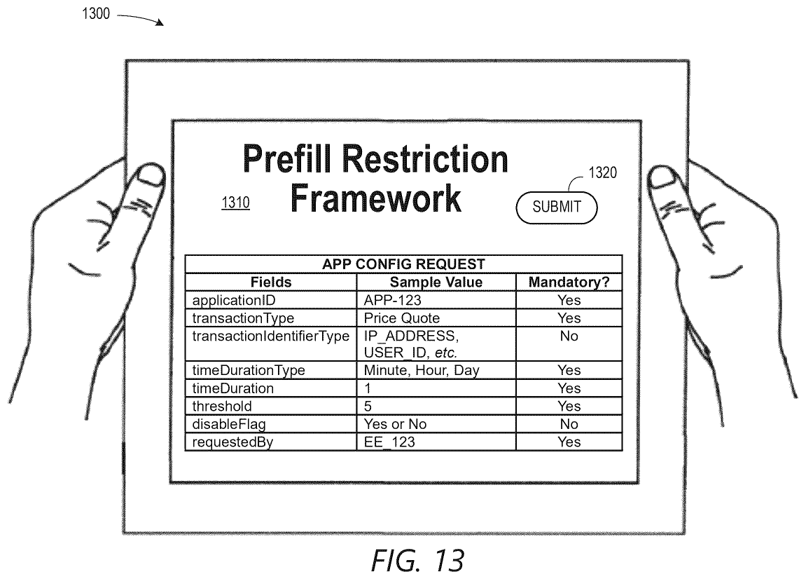

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of enterprises, embodiments may instead be associated with other types of financial enterprises, educational institutions, organizations, etc. instead. FIG. 13 illustrates a handheld tablet 1300 in accordance with some embodiments. A prefill restriction framework display 1310 might, for example, let an operator review, modify or implement application configurations, requests, and responses associated with an enterprise via a “Submit” icon 1320.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed:

1. A prefill restriction system for an enterprise, comprising:
(a) a configuration data store that contains electronic records associated with enterprise applications including, for each application, at least one application identifier and associated prefill restriction; and
(b) a cloud-based prefill restriction tool, coupled to the configuration data store, including:
a computer processor, and
a computer memory coupled to the computer processor and storing instructions that, when executed by the computer processor, cause a back-end application computer server associated with the prefill restriction tool to:
receive a prefill check request, including an application identifier and a transaction identifier, from a consuming application of the enterprise via an Application Programming Interface (“API”),
access the configuration data store to determine a prefill restriction associated with the consuming application,
automatically perform a prefill check based on the prefill restriction and transaction identifier, and
transmit a response to the consuming application indicating a result of the prefill check.

2. The system of claim 1, wherein the prefill check is performed in accordance with at least one of: (i) detection of a cyber event beginning, and (ii) detection of a cyber event ending.

3. The system of claim 2, wherein at least one of said detections is based on a result of an execution of a machine learning algorithm.

4. The system of claim 1, wherein the prefill restriction includes at least one of: (i) preventing more than a threshold number of transactions from a communication address, (ii) preventing more than a threshold number of transactions from a communication address within a predetermined period of time, (iii) preventing more than a threshold number of transactions from a user within a predetermined period of time, and (iv) a machine learning algorithm identifier.

5. The system of claim 1, wherein electronic records in the configuration data store further include, for each application, at least one of: (i) a transaction type, (ii) a transaction identifier type, (iii) a time duration type, (iv) a time duration, (v) a threshold, (vi) a disable flag, (vii) and a requested by identifier.

6. The system of claim 1, wherein the prefill check request further includes at least one of: (i) a transaction type, and (ii) a transaction identifier type.

7. The system of claim 1, wherein the transaction identifier includes at least one of: (i) a communication address, (ii) an Internet Protocol (“IP”) address, (iii) a user identifier, (iv) a state, and (v) a session identifier.

8. The system of claim 1, wherein the result of the prefill check indicates that prefill is “enabled.”

9. The system of claim 1, wherein the result of the prefill check indicates that prefill is “disabled.”

10. The system of claim 1, wherein the prefill restriction tool is able to configure a time duration in accordance with minutes, hours, calendar days, or business days.

11. The system of claim 1, wherein the prefill restriction tool is able to enable or disable prefill checks for specific configurations.

12. The system of claim 1, wherein a configuration request received from an administrator includes at least one of: (i) an application identifier, (ii) a transaction type, (iii) a transaction identifier type, (iv) a time duration type, (v) a time duration, (vi) a threshold, (vii) a disable flag, (viii) a requested by identifier, and (ix) an action.

13. The system of claim 12, wherein a response to the configuration request includes at least one of: (i) a “success” status, (ii) an “error” status, and (iii) a message.

14. A prefill restriction method for an enterprise, comprising:
receiving, by a back-end application computer server associated with a prefill restriction tool, a prefill check request, including an application identifier and a transaction identifier, from a consuming application of the enterprise via an Application Programming Interface (“API”);
accessing a configuration data store to determine a prefill restriction associated with the consuming application, wherein the configuration data store contains electronic records associated with enterprise applications including, for each application, at least one application identifier and associated prefill restriction;
automatically performing a prefill check based on the prefill restriction and transaction identifier; and
transmitting a response to the consuming application indicating a result of the prefill check.

15. The method of claim 14, wherein the prefill check is performed in accordance with at least one of: (i) detection of a cyber event beginning, and (ii) detection of a cyber event ending.

16. The method of claim 15, wherein at least one of said detections is based on a result of an execution of a machine learning algorithm.

17. A non-transitory, computer-readable medium storing instructions, that, when executed by a processor, cause the processor to perform a prefill restriction method for an enterprise, the method comprising:
receiving, by a back-end application computer server associated with a prefill restriction tool, a prefill check request, including an application identifier and a transaction identifier, from a consuming application of the enterprise via an Application Programming Interface (“API”);
accessing a configuration data store to determine a prefill restriction associated with the consuming application, wherein the configuration data store contains electronic records associated with enterprise applications including, for each application, at least one application identifier and associated prefill restriction;
automatically performing a prefill check based on the prefill restriction and transaction identifier; and
transmitting a response to the consuming application indicating a result of the prefill check.

18. The medium of claim 17, wherein the prefill check is performed in accordance with at least one of: (i) detection of a cyber event beginning, and (ii) detection of a cyber event ending.

19. The medium of claim 18, wherein at least one of said detections is based on a result of an execution of a machine learning algorithm.

20. The medium of claim 19, wherein the prefill restriction includes at least one of: (i) preventing more than a threshold number of transactions from a communication address, (ii) preventing more than a threshold number of transactions from a communication address within a predetermined period of time, (iii) preventing more than a threshold number of transactions from a user within a predetermined period of time, and (iv) a machine learning algorithm identifier.
